(19) United States
(12) Patent Application Publication
(10) Pub. No.: US 2021/0030155 A1
(43) Pub. Date: Feb. 4, 2021

(54) Massage Cushion Structure Hung on Seat Back

(71) Applicant: NINGHAI RABBIT AUTOMOTIVE PRODUCTS CO., LTD., Ningbo (CN)

(72) Inventor: Jiangqiang You, Ningbo (CN)

(21) Appl. No.: 16/894,823

(22) Filed: Jun. 7, 2020

(30) Foreign Application Priority Data
Jul. 31, 2019 (CN) 201921230763.X

(51) Int. Cl. A47C 7/42; A61H 9/00

(52) U.S. Cl. CPC A47C 7/425; A61H 2205/081; A61H 2203/0431; A61H 9/0078

(57) ABSTRACT

A massage cushion structure hung on a seat back, includes a back cloth sleeve and a bladder provided in the back cloth sleeve. The back cloth sleeve includes an upper portion, a middle portion, and a lower portion which are sequentially connected to each other in a smooth transition. The middle portion has a trapezoid structure narrow at its upper end and wide at its lower end. The bladder is in a gourd shape and includes an upper bladder and a lower bladder which are in communication with each other. A connecting area between the upper bladder and the lower bladder is configured to constrict inward. The bladder is located in the middle portion of the back cloth sleeve and supports the middle portion of the back cloth sleeve to bulge.

### CROSS REFERENCE TO RELATED APPLICATIONS

The present application claims the benefit of Chinese Patent Application No. 201921230763.X filed on Jul. 31, 2019, the contents of which are incorporated herein by reference in their entirety.

### FIELD OF THE INVENTION

The present disclosure relates to the technical field of car accessories, and in particular to a massage cushion structure hung on a seat back.

### BACKGROUND OF THE INVENTION

With the growing development of economy, cars become more and more popular. Meanwhile, car seats walk into people's daily life and become a living necessity for car owners to enjoy driving and comfortable car life. Now consumers know better about car seats, and have increasingly high demands on car seats. Consumers' concerns are no longer simply on materials, appearance, color, and safety of the car seats, but more on their comfortableness, styles, functions and so on.

When a driver steps on the accelerator or the brake during driving, a backward force is produced from the driver's foot towards the hip. After being transmitted to the driver' hip, this force is first transmitted, via the hip, to the driver's lower waist and then to the driver's middle waist, and it is when the force is transmitted to the driver's middle waist that the force is transmitted to the seat back. In this case, the driver's lower waist suffers from a shear force relative to the hip, and as time goes by the driver may develop symptoms of lumbar disc herniation, lumbar muscle strain and the like.

Existing car seat structures fail to provide a car seat capable of providing comfortableness for the back of users. This is because the more functions a seat integrates, the more complex its style is, and the more difficult it is to implement the seat. Sometimes, a style that a consumer likes does not match a function that the consumer wants, i.e., the style and the function conflict with each other. In this case, it is more difficult to implement the seat, and it is even not possible to manufacture the seat.

In view of the above, the inventor of the present disclosure develops a massage cushion structure hung on a seat back, which, as a car accessory, can be mounted on a car seat back, to provide a comfortable seat back structure for a driver.

### SUMMARY OF THE INVENTION

One objective of the present disclosure is to provide a massage cushion structure hung on a seat back. The massage cushion structure is designed with a structurally reasonable bladder and a matching back cloth sleeve, and can provide adequate support for a user's entire back to relieve the user's fatigue and improve comfortableness of the seat back.

In order to realize the above objective, the present disclosure adopts the following technical solutions. A massage cushion structure hung on a seat back includes a back cloth sleeve and a bladder provided in the back cloth sleeve. The back cloth sleeve includes an upper portion, a middle portion, and a lower portion which are sequentially connected to each other in a smooth transition. The middle portion is of a trapezoid structure which is narrow at an upper end thereof and wide at a lower end thereof. The bladder is in a gourd shape and includes an upper bladder and a lower bladder which are in communication with each other. A connecting area between the upper bladder and the lower bladder is configured to constrict inward. The bladder is located in the middle portion of the back cloth sleeve and supports the middle portion of the back cloth sleeve to bulge.

According to a preferred technical solution of the present disclosure, the back cloth sleeve is provided at an upper end and a lower end thereof with clamping strips. The clamping strip at the upper end of the back cloth sleeve is detachably connected to a buckle and is mounted on a supporting column at a top of the seat back by means of the buckle. The clamping strip at the lower end of the back cloth sleeve is inserted into a connecting gap between the seat back and a seat base.

According to a preferred technical solution of the present disclosure, the upper bladder is of an elliptical truncated cone structure, and the lower bladder is of an elliptical spherical structure. The connecting area between the upper bladder and the lower bladder constricts inward to form a semicircular structure.

According to a preferred technical solution of the present disclosure, the upper portion is of a strip structure and is provided correspondingly at a shoulder-resting position of the seat back; the lower portion is of a trapezoid structure narrow at an upper end thereof and wide at a lower end thereof and is inserted into a connecting area between the seat back and a seat base. The upper end of the lower portion has a width smaller than a width of the lower end of the middle portion.

According to a preferred technical solution of the present disclosure, the middle portion is provided at two sides thereof with back straps for connecting to the seat back. The back straps are located at a position where a width of the middle portion is the largest, and the back straps correspond to a waist-resting position of the seat back.

Compared with existing technologies, the present disclosure is advantageous in the gourd-shaped bladder which includes the upper bladder and the lower bladder. The upper bladder is used to support the spine below the shoulder, and the lower bladder is used to support the dented part of the human body at the waist. The connecting area between the upper bladder and the lower bladder is configured to constrict inward. The bladder structure of the present disclosure is adapted to the contacting area of the human back and the seat back, and can therefore provide adequate support for a user's back to relive the user's fatigue caused by driving and improve the comfortableness of driving. The structure of the back cloth sleeve of the present disclosure is adapted to the bladder, and is adapted to be mounted on a car seat. The entire back cloth sleeve has a compact and reasonably designed structure.

### BRIEF DESCRIPTION OF THE DRAWINGS

The present disclosure will be described in detail below in conjunction with the accompanying drawings and preferred embodiments, but those persons of ordinary skill in the art shall appreciate that the accompanying drawings are drawn only for the purpose of illustrating the preferred embodiments and therefore shall not be construed as limiting the scope of the present disclosure. Also, unless otherwise specifically stated, the accompanying drawings are intended only for conceptually representing components or structures of objects being described and may contain exaggerated representations, and the accompanying drawings are not necessarily drawn to scale.

FIG. 1 is a schematic diagram showing a structure of a massage cushion structure provided by the present disclosure;

FIG. 2 is a schematic diagram showing a structure of a back cloth sleeve;

FIG. 3 is a schematic diagram showing a structure of a bladder; and

FIG. 4 is a diagram showing the massage cushion structure of the present disclosure in use.

### DETAILED DESCRIPTION OF THE EMBODIMENTS

The present disclosure will be described in detail below in conjunction with the accompanying drawings.

For a clearer understanding of the objectives, technical solutions, and advantages of the present disclosure, a detailed description of the present disclosure is provided below in conjunction with the accompanying drawings and embodiments. It shall be appreciated that the specific embodiments described herein are only for the purpose of illustrating the present disclosure and are not intended for limiting the present disclosure.

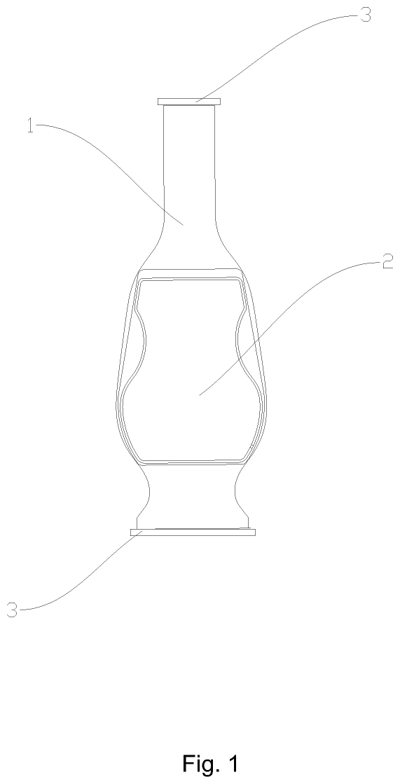

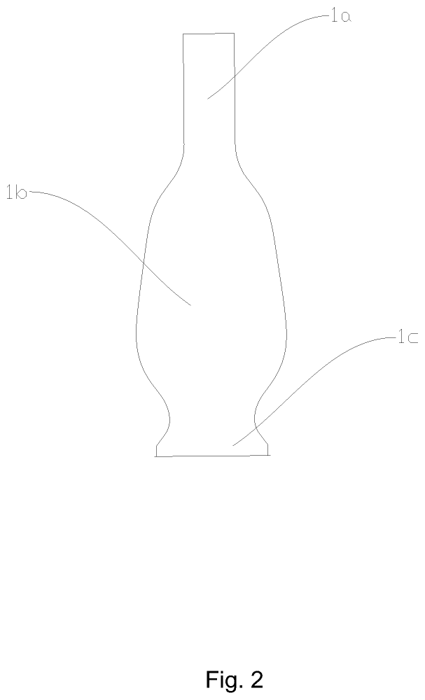

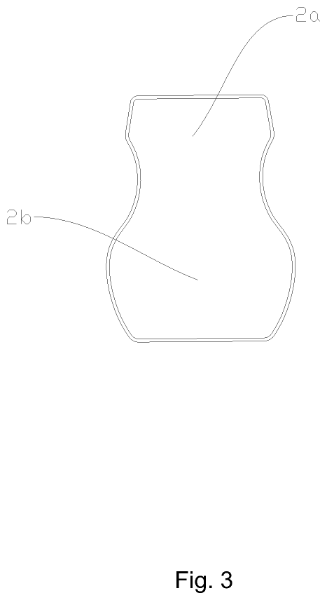

As shown in FIGS. 1 to 4, a massage cushion structure hung on a seat back includes a back cloth sleeve 1 and a bladder 2 provided in the back cloth sleeve 1. The back cloth sleeve 1 includes an upper portion 1a, a middle portion 1b, and a lower portion 1c which are sequentially connected to each other in a smooth transition. The middle portion 1b is of a trapezoid structure which is narrow at an upper end thereof and wide at a lower end thereof. The bladder 2 is in a gourd shape and includes an upper bladder 2a and a lower bladder 2b which are in communication with each other. A connecting area between the upper bladder 2a and the lower bladder 2b is configured to constrict inward. The bladder 2 is located in the middle portion 1b of the back cloth sleeve 1 and supports the middle portion 1b of the back cloth sleeve 1 to bulge.

The back cloth sleeve 1 is provided at an upper end and a lower end thereof with clamping strips 3. The clamping strip 3 at the upper end of the back cloth sleeve 1 is detachably connected to a buckle and is mounted on a supporting column at a top of a seat back 5 by means of the buckle. The clamping strip 3 at the lower end of the back cloth sleeve 1 is inserted into a connecting gap between the seat back 5 and a seat base 6. By providing the clamping strips 3, the entire back cloth sleeve 1 can be supported and used as a skeleton structure. Besides, in order to realize a connection between an upper end of the massage cushion structure of the present disclosure and a car seat, it is necessary to provide the buckle to match the clamping strip 3.

The upper bladder 2a is of an elliptical truncated cone structure, and the lower bladder 2b is of an elliptical spherical structure. The connecting area between the upper bladder 2a and the lower bladder 2b constricts inward to form a semicircular structure. The structural design of the bladder 2 determines a structure of a front face of the whole massage cushion. The upper bladder 2a is provided to support a user's spine under the shoulder, and the lower bladder 2b is provided to support the user's waist, so that the whole back of the user can be well supported, and the fatigue caused by long-time sitting can be relieved.

The upper portion 1a is of a strip structure and is provided correspondingly at a shoulder-resting position of the seat back 5. The lower portion 1c is of a trapezoid structure narrow at an upper end thereof and wide at a lower end thereof and is inserted into a connecting area between the seat back 5 and the seat base 6. The upper end of the lower portion 1c has a width smaller than a width of the lower end of the middle portion 1b. According to the design of the massage cushion structure of the present disclosure, the middle portion 1b ensures arrangement of the bladder 2; the upper portion 1a and the lower portion 1c simplifies the entire structure as much as possible, which reduces the area of the product so that it can be adaptively mounted on the car seat; the upper portion 1a is of a strip structure and corresponds to the supporting column at the top of the car seat back 5; the lower portion 1c is of a trapezoid structure and corresponds to the connecting area between the seat back 5 and the seat base 6.

The middle portion 1b is provided at two sides thereof with back straps 4 for connecting to the seat back 5. The back straps 4 are located at a position where a width of the middle portion 1b is the largest, and the back straps correspond to a waist-resting position of the seat back 5. By providing the back straps 4, the position for mounting the massage cushion structure of the present application is further determined. That is, a part of the lower bladder 2b that bulges to a largest height is required to correspond straight to the waist-resting position.

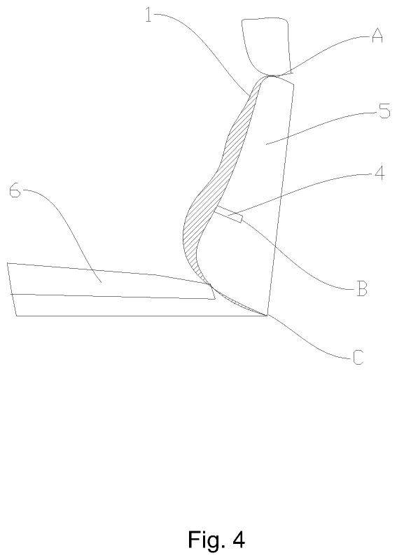

The specific mounting of the massage cushion structure of the present disclosure is shown in FIG. 4. The massage cushion structure of the present disclosure is mounted by way of three positions which are shown in FIG. 4 as position A, position B, and position C. Fixed mounting is realized by means of the buckle at position A, by means of the back straps 4 (for example by means of Velcro, ties, elastic strings, etc.) at position B, and by inserting into the car seat at position C.

In describing the massage cushion structure of the present disclosure, it shall be noted that terms such as “center”, “upper”, “lower”, “left”, “right”, “vertical”, “horizontal”, “inner”, and “outer” and the like used for indicating orientations or positions are based on the orientations or positions shown in the accompanying drawings, and are used simply for facilitating and simplifying the description of the present disclosure rather than for indicating or suggesting that a device or element being described must have a particular orientation or be configured and operated in a particular orientation. These terms therefore shall not be construed as limiting the present disclosure. Further, terms such as “first”, “second”, and “third” and the like are simply used for the purpose of description rather than for indicating or suggesting relative importance.

In describing the massage cushion structure of the present disclosure, it shall be noted that unless otherwise expressly specified and defined, terms such as “mount”, “arrange”, “connected to each other”, “connect”, and “connection” and so on shall be interpreted in a broad sense. For example, “connection” can refer to a fixed connection, a detachable connection, or a one-piece connection, or can refer to a mechanical connection, or an electrical connection, or can refer to a direct connection, an indirect connection through an intermedium, or a communication between two elements. Those persons of ordinary skill in the art can interpret specific meanings of these terms used herein in the present disclosure based on specific situations.

The above is a detailed introduction to the present disclosure. Specific individual examples are used herein to illustrate the principles and embodiments of the present disclosure, but the description of the above embodiments is only provided for facilitating the understanding of the present disclosure and its core concepts. It shall be noted that those persons of ordinary skill in the art can make improvements and modifications to the present disclosure without departing from the principles of the present disclosure, and that those improvements and modifications shall also fall within the protection scope as defined in the claims of the present disclosure.

1. A massage cushion structure hung on a seat back, comprising a back cloth sleeve and a bladder provided in the back cloth sleeve, wherein the back cloth sleeve comprises an upper portion, a middle portion, and a lower portion which are sequentially connected to each other in a smooth transition, the middle portion being of a trapezoid structure which is narrow at an upper end thereof and wide at a lower end thereof; and
wherein the bladder is in a gourd shape and comprises an upper bladder and a lower bladder which are in communication with each other, a connecting area between the upper bladder and the lower bladder being configured to constrict inward, and the bladder is located in the middle portion of the back cloth sleeve and supports the middle portion of the back cloth sleeve to bulge.

2. The massage cushion structure hung on a seat back according to claim 1, wherein the back cloth sleeve is provided at an upper end and a lower end thereof with clamping strips, wherein the clamping strip at the upper end of the back cloth sleeve is detachably connected to a buckle and is mounted on a supporting column at a top of the seat back by means of the buckle, and the clamping strip at the lower end of the back cloth sleeve is inserted into a connecting gap between the seat back and a seat base.

3. The massage cushion structure hung on a seat back according to claim 1, wherein the upper bladder is of an elliptical truncated cone structure, and the lower bladder is of an elliptical spherical structure, the connecting area between the upper bladder and the lower bladder constricting inward to form a semicircular structure.

4. The massage cushion structure hung on a seat back according to claim 1, wherein the upper portion is of a strip structure and is provided correspondingly at a shoulder-resting position of the seat back; the lower portion is of a trapezoid structure narrow at an upper end thereof and wide at a lower end thereof and is inserted into a connecting area between the seat back and a seat base, the upper end of the lower portion having a width smaller than a width of the lower end of the middle portion.

5. The massage cushion structure hung on a seat back according to claim 1, wherein the middle portion is provided at two sides thereof with back straps for connecting to the seat back, wherein the back straps are located at a position where a width of the middle portion is the largest, and the back straps correspond to a waist-resting position of the seat back.
